(19) United States
(12) Patent Application Publication
(10) Pub. No.: US 2001/0032249 A1
(43) Pub. Date: Oct. 18, 2001

(54) Computer system for an internal computer network

(76) Inventor: Andreas Worch, Berlin (DE)

Correspondence Address: Randolph A. Smith, Smith Patent Office, Suite 200, 1901 Pennsylvania Ave., N.W., Washington, DC, 20006-3433, US

(21) Appl. No.: 09/795,975

(22) Filed: Mar. 1, 2001

(30) Foreign Application Priority Data
Mar. 6, 2000 (DE) 100 10 349.9
Sep. 16, 2000 (DE) 100 45 922.6

(51) Int. Cl. G06F 15/16

(52) U.S. Cl. 709/208

(57) ABSTRACT

An internal computer network comprises a plurality of electronic computer subsystems for forming a multiprocessor system or mainframe computer. A plurality of plug-in places for central processing units (CPUs 11) are disposed on a circuit board. The CPUs (11) are connected through internal buses (23) to backplanes (22a, 22b, 22c, 22d, 22e). The backplanes (22a, 22b, 22c, 22d, 22e) in turn connect slave cards (17, 18, 19) to a master card.

### BACKGROUND OF THE INVENTION

1. Field of the Invention

The invention relates to an internal computer network comprising a plurality of electronic computer subsystems for forming a multiprocessor or mainframe computer.

2. Discussion of the Related Art

Usually a plurality of central processing units (CPUs) in a multiprocessor system communicate through network adapters and that places a burden on the network due to the data load that must be dealt with and thus the speed slows down. Merely raising the clock frequency of the processors from 400 to 500 MHz, for instance, means that the computer speed will be increased by only 25%, and of that value a maximum of 5% is all that is left for the overall system.

### SUMMARY OF THE INVENTION

It is an object of the present invention to provide a computer system capable of adapting its operating performance to the growing demands of users and increasing the computing power while, at the same time, maintaining the data processing speed at a constantly high level.

This object as well as other objects is accomplished by an internal computer network comprising a plurality of electronic computer subsystems for forming a multiprocessor system or mainframe computer. A plurality of plug-in places for central processing units (CPUs) is disposed on a circuit board. The CPUs are connected through internal buses to backplanes which in turn are connected to slave cards. On each slave card, a plurality of plug-in places is provided for at least one of DSP units and PLD units and network adapter units.

The computer system may be connected to a processor bridge slave card (PB slave card) comprising a plurality of plug-in places for processor bridge units (PB units). This permits the computer subsystems to be connected directly without loading the local area network (LAN).

The measures described make it possible to interconnect any desired number of CPUs. This avoids data becoming jammed in a LAN and, at the same time, accelerates the operating performance of the network.

Any desired number of CPUs can communicate with each other across processor bridges rather than in the conventional way through network adapters. Each CPU has its own plug-in processor bridge that allows it to communicate with another CPU of another computer subsystem. Any desired number of computer subsystems may be interconnected by such processor bridges inside the computer.

An internal network is established in the form of a multi-processor system. The processor bridge adapters, which interconnect the various CPUs, may be connected in a ring bus, for example. Any desired number of the various processors and co-processors of the computer subsystems are located on their own respective circuit boards, and these are interconnected through backplanes. Thus it becomes possible to execute different application programs in parallel and manage them by any desired number of CPUs on a circuit board (master card) without having the computing performance slowed down or the network overloaded by the data traffic to be handled.

Different coprocessors may be associated with one central processing unit and may be addressed flexibly. This arrangement likewise permits interprocessor communication. One master card may allow a number of processing units (CPU 1 to CPU n) to be provided. The operating systems used in such a multiprocessor system, for instance, may be Linux or comparable Unix derivatives.

### BRIEF DESCRIPTION OF THE DRAWINGS

The above objects and features of the present invention will be apparent to those skilled in the art from the following description of the preferred embodiments thereof when considered in conjunction with the appended drawings in which:

FIG. 1 is a schematic block diagram of a circuit board (master card) including any desired number of central processing units (CPUs) connected to backplanes.

FIG. 2 is a schematic block diagram of a circuit board (slave card) including any desired number of DSP units connected to backplanes.

FIG. 3 is a schematic block diagram of a circuit board (slave card) including any desired number of PLD units connected to backplanes.

FIG. 4 is a schematic block diagram of a circuit board (slave card) including any desired number of network adapter (NA) units connected to backplanes.

FIG. 5 is a schematic block diagram of a circuit board (slave card) including any desired number of processor bridge (PB) units connected to backplanes.

FIG. 6 is an isometric illustration of the individual computer subsystems that are interconnected by PB units and inserted in a conventional 19-inch casing.

FIG. 7 is a schematic block diagram of the connections existing between the individual components when inserted in the casing.

### DETAILED DESCRIPTION OF THE PREFERRED EMBODIMENTS

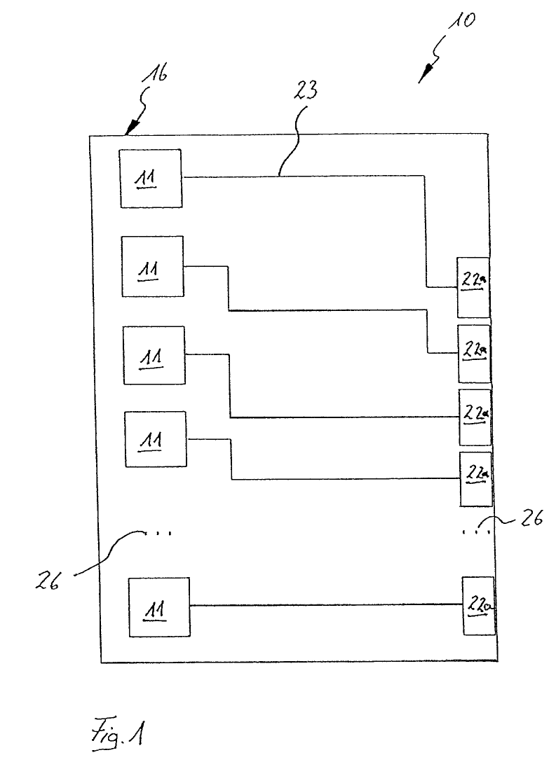

FIG. 1 illustrates a central processing unit master card 16 (CPU master card) implemented by 19-inch technology. There is a plurality of plug-in places 26 for CPUs 11 that are arranged on the CPU master card 16.

The CPUs 11 are connected by internal buses 23 to backplanes 22a. The backplanes 22a are for transmitting data and exchanging information between the individual components of the computer subsystems 10.

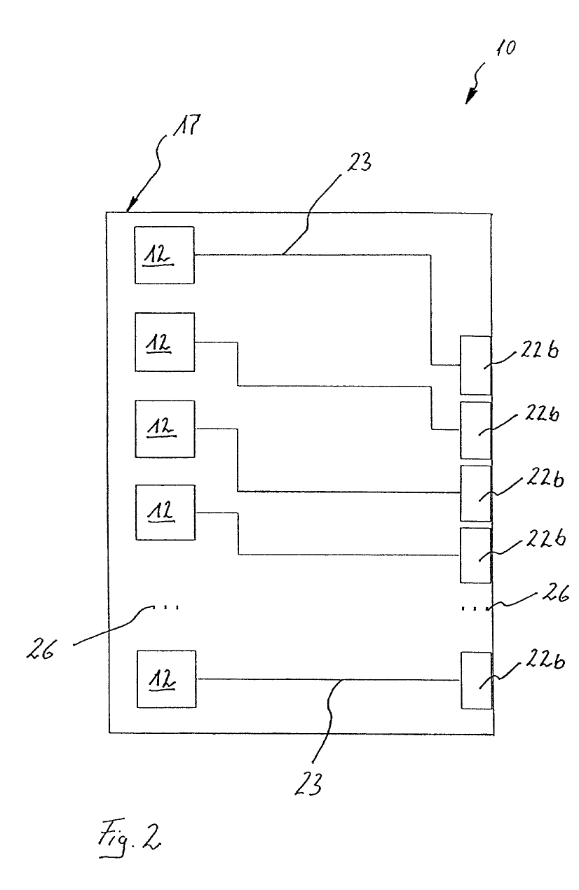

The digital signal processor slave card 17 (DSP slave card) shown in FIG. 2 comprises a plurality of plug-in places 26 for DSP units 12. The processors again are connected by internal buses 23 to the backplanes 22b.

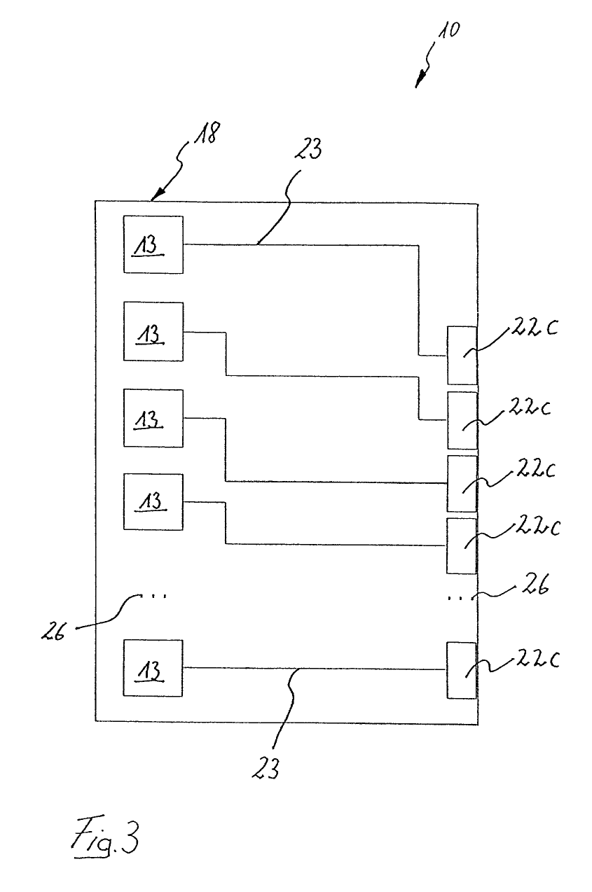

FIG. 3 shows the circuit board of a programmable logic device slave card 18 (PLD slave card). A plurality of PLD units 13 are plugged into plug-in places 26 provided on the PLD slave card 18. The number of plug-in places 26 is limited only by the configuration of the circuit board. Again the PLD units 13 are connected by the internal buses 23 to the backplanes 22c.

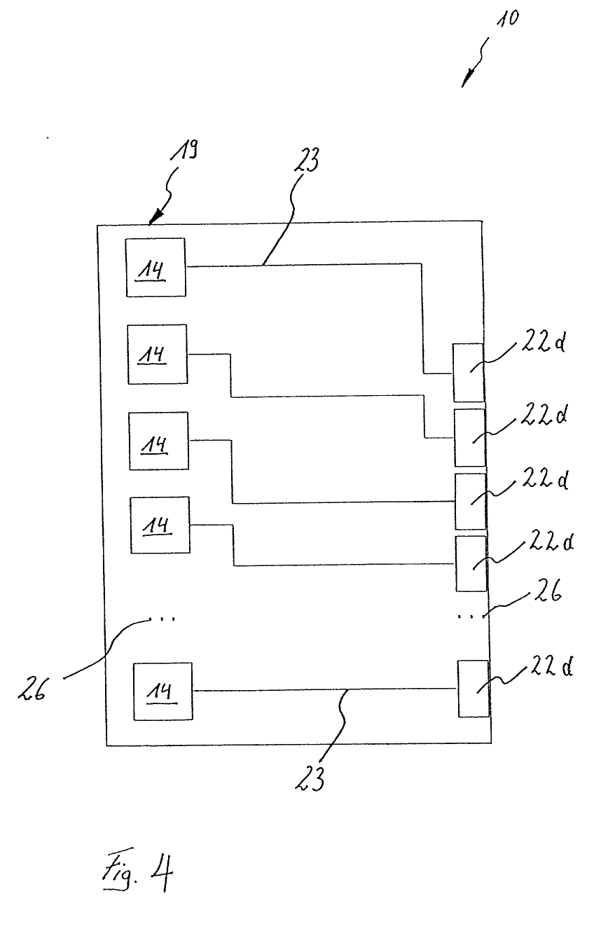

FIG. 4 shows a circuit board of a network adapter slave card 19 (NA slave card). This NA slave card 19 is formed with a plurality of plug-in places 26 to receive network adapter units 14 (NA units). Internal buses 23 connect the NA units 14 to their backplanes 22d, thus establishing a connection with the entire computer subsystem 10.

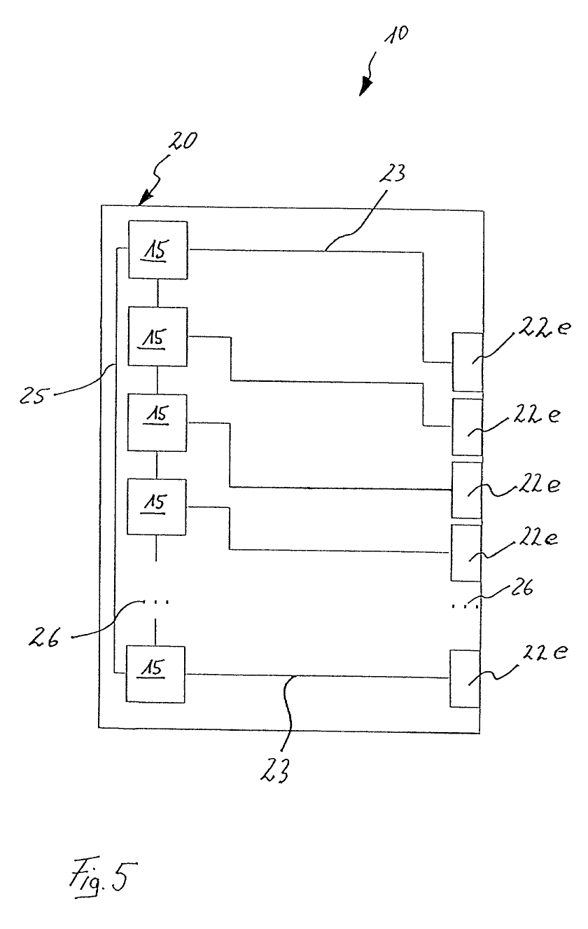

FIG. 5 shows a processor bridge slave card 20 (PB slave card) provided with a plurality of plug-in places 26 for processor bridge units 15 (PB units). The PB units 15 are connected by internal buses 23 to their backplanes 22e. Processor bridge connections 25 establish connections among the PB units 15.

PCI or SCI buses are especially well suited for use as processor bridge connections 25. In particular, the SCI bus supports bus mastering. Adapters may function either as a master module or as a slave module. Master-type adapters can relieve processors quite considerably, especially when multi-tasking operating systems are employed. The processor bridge connections 25 may be embodied by a ring bus.

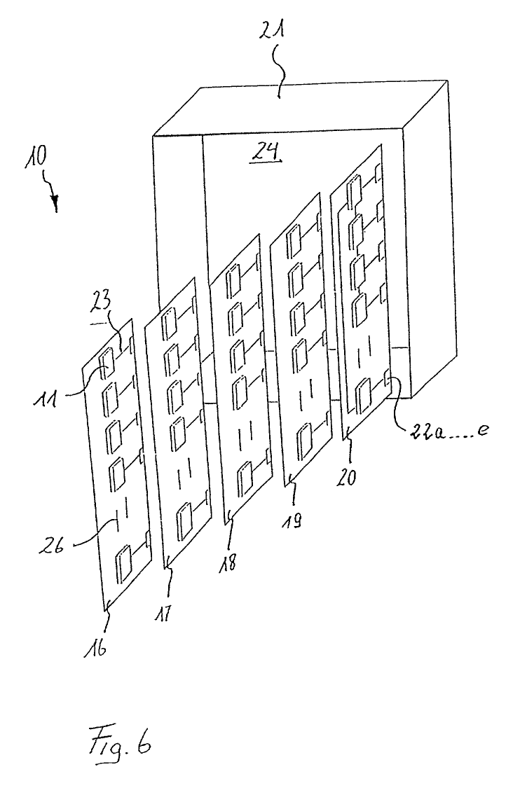

FIG. 6 shows an overall system housed in a commercially available 19-inch casing 21. The back 24 of the 19-inch casing 21 is provided with plug-in places (not shown) where CPU master cards 16, DSP slave cards 17, PLD slave cards 18, NA slave cards 19, and PB slave cards 20 may be plugged in.

In this manner, a multiprocessor system or mainframe computer is provided which may be composed of a plurality of computer subsystems 10. The computer subsystems 10, in horizontal division, are connected through their respective internal buses 23 to their respective backplanes 22a, 22b, 22c, 22d, and 22e.

The PB slave cards 20 permit communication with the vertically arranged CPUs 11 via a plurality of plug-in places 26. In this manner, each horizontal computer subsystem 10 is incorporated in an internal high-speed network.

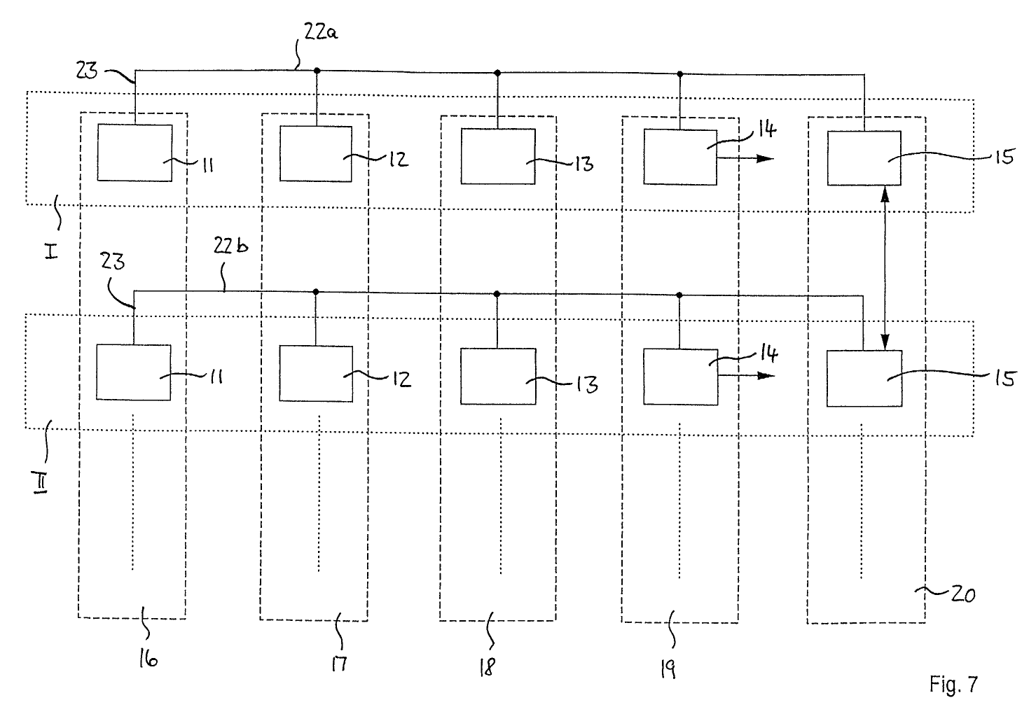

FIG. 7 is a diagrammatic presentation of the connections formed between the individual components when the CPU master card 16, the DSP slave card 17, the PLD slave card 18, the NA slave card 19, and the PB slave card 20 are plugged into the casing 21. The internal buses 23 and the respective backplanes 22a, 22b, 22c, 22d, 22e define corresponding horizontal computer systems I, II, etc.

The horizontal computer systems I, II, etc., exchange data via the PB units 15 on the PB slave card 20. Furthermore, the computer systems I, II, etc., may exchange data with the LAN through the respective NA units 14, as is known per se.

With the arrangement described above, the plurality of CPUs 11 each having (being provided with) their own memory and using their own operating system (whereby they differ from symmetric multiprocessor machines also called SMP machines), are connected by means of NA units 14 to the local area network of a multiprocessor or mainframe computer system. The plurality of CPUs 11 are forming part of this network. At the same time, an internal network is formed with the arrangement described, specifically with the internal buses 23, the plug-in places 26 on the respective backplanes 22a, 22b, 22c, 22d, 22e and the PB units 15 on the PB slave card 20. Thus data can be exchanged through this internal network between the various horizontal computer systems I, II, etc., and specifically the CPUs 11.

This offers the opportunity of supplementing or upgrading multiprocessor systems or mainframe computers by means of a plurality of additional computer subsystems 10. These additional computer subsystems 10 handle a substantial portion of the data traffic through the internal network which is established particularly with the help of the internal buses 23 and the PB units 15.

Therefore, adding computer subsystems 10 to the multiprocessor system or mainframe computer does not cause overloading of the multiprocessor or mainframe computer LAN which usually exists in parallel and to which the plurality of CPUs 11 are coupled through the NA units 14. Thus one or more internal networks may be formed within the multiprocessor or mainframe computer. Also the computer subsystems 10 will use the connections of the parallel LAN of the multiprocessor or mainframe computer only as may be required. For example, they can be used for data traffic between two internal networks each designed as specified above, for configuration purposes, or for a booting operation.

Just like the plurality of CPUs 11, the DSP units 12 and the PLD units 13 may also be coupled to the internal network by means of DSP slave cards 17 and PLD slave cards 18, respectively (cf. FIG. 7). The arrangement illustrated in FIG. 7 may be used for electronic data exchange between the plurality of CPUs 11 disposed on the individual CPU master card 16 and the DSP units 12 and the PLD units 13, with the data passing through the internal buses 23, the backplane 22, and the PB units 15. The PLD units 13 and/or the DSP units 12 may be associated with the plurality of CPUs 11 depending on the task to be performed.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

The text of German priority application nos. 100 10 349.9 filed Mar. 6, 2000 and 10045 922.6 filed Sep. 16, 2000 are hereby incorporated by reference.

What is claimed is:

1. An internal computer network comprising a plurality of electronic computer subsystems for forming at least one of a multiprocessor and a mainframe computer, wherein a plurality of plug-in places for central processing units are disposed on a circuit board, said central processing units are connected through internal buses to backplanes which in turn are connected to slave cards, each of said slave cards including a plurality of plug-in places for at least one of a DSP unit and a PLD unit and a network adapter unit.

2. The internal computer network as claimed in claim 1, further comprising at least one PB unit disposed on a PB slave card.

3. The internal computer network as claimed in claim 1, further comprising an additional plurality of plug-in places disposed in said electronic computer subsystems for allowing PB units to be connected to said electronic computer subsystems.

4. The internal computer network as claimed in claim 1, where in one of said electronic computer subsystems includes at least one said central processing unit, at least one said DSP unit, at least one said PLD unit, and at least one said network adapter unit which is connectable through a PB unit to another of said electronic computer subsystems.

5. The internal computer network as claimed in claim 1, further comprising coprocessors connected to said central processing units through internal buses.

6. The internal computer network as claimed in claim 1, wherein said PLD units are connected to said central processing units through internal buses.

7. The internal computer network as claimed in claim 1, wherein each said central processing unit has its own operating system.

8. The internal computer network as claimed in claim 1, wherein said electronic computer subsystems are disposed so as to operate in parallel.

9. The internal computer network as claimed in claim 1, wherein said central processing units are each connected to a respective PB unit.

10. The internal computer network as claimed in claim 1, wherein at least one said central processing units is disposed on a single CPU master card for carrying out a plurality of user applications.

11. The internal computer network as claimed in claim 1, further comprising a plurality of different application programs distributed among a plurality of said central processing units and said different application programs are capable of being executed by said plurality of electronic computer subsystems.

12. The internal computer network as claimed in claim 1, further comprising CPU master cards, wherein at least one of said CPU master cards and said slave cards are provided in 19 inch technology.

13. The internal computer network as claimed in claim 1, further comprising a casing and wherein said electronic computer subsystems are arranged in said casing so as to be separated from one another.
